(19) United States
(12) Patent Application Publication
(10) Pub. No.: US 2010/0170626 A1
(43) Pub. Date: Jul. 8, 2010

(54) METHOD FOR THE PRODUCTION OF POLYMER-COATED METAL FOILS, AND USE THEREOF

(75) Inventors: Rene Lochtman, Mannheim (DE); Jürgen Kaczun, Wachenheim (DE); Norbert Wagner, Mutterstadt (DE); Jürgen Pfister, Speyer (DE); Dieter Hentschel, Boblingen (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/601,669

(22) PCT Filed: May 20, 2008
(86) PCT No.: PCT/EP2008/056160

§ 371 Date: Nov. 24, 2009

(30) Foreign Application Priority Data
May 24, 2007 (EP) 07108828.0

(51) Int. Cl. B32B 38/08; C25D 5/34; B05D 3/02; B05D 3/10; B05D 3/04; B32B 37/02; B32B 38/10; B32B 38/16; C25D 5/48; C25D 5/54

(52) U.S. Cl. 156/150; 205/183; 427/372.2; 427/343; 156/60; 156/247; 156/307.5

(57) ABSTRACT

The invention relates to a method for producing polymer-coated metal foils, comprising the following steps:
(a) applying a base layer (7) onto a support foil (3), with a dispersion (5) which comprises electrolessly and/or electrolytically coatable particles in a matrix material,
(b) at least partially drying and/or at least partially curing the matrix material,
(c) forming a metal layer (19) on the base layer (7) by electroless and/or electrolytic coating of the base layer (7) comprising the electrolessly or electrolytically coatable particles,
(d) applying a polymer (23) to the metal layer (19).

Furthermore, the invention relates to a use of the polymer-coated metal foil for the production of printed circuit boards.

The invention relates to a method for producing polymer-coated metal foils. Furthermore, the invention relates to a use of such foils.

Polymer-coated metal foils are used, for example, for the production of electrical printed circuit boards. To this end, the polymer-coated metal foils are laminated to a printed circuit board support. A conductor-track structure is then produced from the metal layer of the metal foil. To this end, the portions not needed for the conductor-track structure are removed. The polymer coating with which the metal foil is laminated to the printed circuit board support acts as insulator. This ensures that no current can flow through the support and, respectively, the polymer coating.

Currently, the method of producing metal foils, generally copper foils, which are used for printed circuit board production deposits copper electrically onto a support. The thickness of the copper layer here is generally in the range from 3 to 5 μm. The support is generally a copper layer of from 18 to 72 μm, onto which a separating layer has been applied, for example composed of chromium. By virtue of the separating layer, the support can be removed from the electrically deposited thin copper layer. In printed circuit board fabricate, the thin deposited copper layer with layer thickness of from 3 to 5 μm is transferred to a semifinished product. Then the support composed of copper with the chromium coating is removed. The support is generally sent for disposal and not reused.

A disadvantage of this process is that the high copper consumption generates high costs. In addition, a large amount of copper- and chromium-containing waste is produced.

A further disadvantage of the copper foil of the prior art is the occurrence of dimensional changes or of rupture in the thin copper layer during removal of the support layer. Rupture occurs particularly by virtue of poor separation. One possibility, for example, is that a portion of the copper layer of thickness less than 5 μm is dragged away with the other material. This leads to holes in the final product. On the other hand, another possibility is that a portion of the support remains on the final product. This is likewise undesirable.

It is an object of the present invention to provide a method which can produce a polymer-coated metal foil for printed circuit board fabricate, where little to absolutely no copper waste arises during the production of the foil, and the foil can easily be transferred to a printed circuit board support.

The object is achieved by a method for producing polymer-coated metal foils, which comprises the following steps:
(a) applying a base layer onto a support foil, with a dispersion which comprises electrolessly and/or electrolytically coatable particles in a matrix material,
(b) at least partially drying and/or at least partially curing the matrix material,
(c) forming a metal layer on the base layer by electroless and/or electrolytic coating of the base layer comprising the electrolessly and/or electrolytically coatable particles,
(d) applying a polymer to the metal layer.

By virtue of the application of the dispersion which comprises the electrolessly and/or electrolytically coatable particles in a matrix material, there is no requirement to provide a support which is electrolessly and/or electrolytically coatable with a metal. It is possible to use a support foil composed of a material more advantageous than, for example, chromed copper. It is possible, for example, to use a support foil composed of a polymer material. The support foil can be continuous foil or else single sheet. The thickness of the support foil is generally about 10-500 μm.

In order that the support foil can subsequently be removed without damaging the metal layer, it is preferable that the support foil has a surface composed of a material which adheres only weakly to the base layer. One possibility here is that the support foil has been coated with a release agent, and as an alternative it is also possible that the foil has been fabricated entirely from a material which adheres weakly to the base layer. Weak adhesion means that the adhesion of the base layer provided with the metal layer to the support foil is weaker than the adhesion of the metal layer with the polymer applied in step (d) to a support to which the polymer-coated side of this is applied.

A further advantageous of the inventive method is that the dispersion which comprises the electrolessly and/or electrolytically coatable particles in a matrix material can, as a function of the average diameter of the electrolessly and/or electrolytically coatable particles, be applied at any desired layer thickness to the support foil. It is also possible to form only a thin metal layer on the dispersion, so that the subsequent metal layer assumes a total thickness of less than 20 μm, preferably less than 10 μm and particularly preferably less than 5 μm. This is particularly desirable in the production of electronic components in high-performance electronics.

A suitable material for the support foil, as a function of the constitution of the base layer, is generally commercially available polymer materials, e.g. fluoropolymers, for example polytetrafluoroethylene (PTFE), polyvinylidene fluoride, polyvinyl fluoride (PVF), ethylene-tetrafluoroethylene (EFE) or silicone polymers, for example polydimethylsiloxane polymers, and also modified cellulose triacetate (CTA), polypropylene, poly-4-methylpentene-1 (TDX), modified polyesters (e.g. Pacothane™ by Pacothane Technologies), polyethylene, polyethylene terephthalate (PET), polyamides or polyimides, as long as the respective base layer has weak adhesion to the support foil, Particularly preferred materials for the support foil are polytetrafluoroethylene (PTFE), polyvinyl fluoride (PVF), ethylene-tetrafluoroethylene (EFE), modified cellulose triacetate (CIA), poly-4-methylpentene-1 (TDX), modified polyesters (e.g. Pacothane™ by Pacothane Technologies), polyester and polyimide.

When the support foil has been coated with a suitable release agent, a suitable material for the support foil is any of the materials which can be used to produce foils. Examples of these are polymers or metals. Examples of suitable materials for the support foil are polyolefins, such as PE, PP, PET, polyamide and polyimide, but also thin fiber-reinforced epoxy or phenolic resin foils. Particularly suitable materials are polyester, polyimide, cellulose triacetate and fiber-reinforced epoxy and phenolic resin foils. Particularly for applications in the sector of printed circuit board production, the materials are preferably heat-resistant up to about 200° C. and have sufficient ultimate tensile strength to permit processing.

To the extent that the support foil has not been fabricated from a material which has only poor adhesion to the base layer, it is then coated with a release agent. All materials that have a high bonding force with the surface of the support foil which is coated with the release agent, and a low bonding force with the dispersion applied thereon, are suitable as a release agent for coating the support foil. The person skilled in the art will select a suitable release agent, depending on the composition of the dispersion. The release agent may be a suitable polymer, for example a vinyl alcohol, a silicone polymer or a fluoropolymer or a low molecular weight fat, wax or oil. Release agents which have a low surface tension of less than 30 mN/m relative to air are preferably used. These are for example fluoropolymers such as polytetrafluoroethylene (PTFE), polyvinylidene fluoride, polyvinyl fluoride (PVF), ethylene-tetrafluoroethylene (EFE), or silicone polymers, for example polydimethylsiloxane polymers and modified cellulose triacetate (CIA). Polytetrafluoroethylene (PTFE), polyvinyl fluoride (PVF), ethylene-tetrafluoroethylene (EFE) and modified cellulose triacetate (CIA) are particularly preferred as release agents. As a function of the temperature at which, for example, a printed circuit board support is subsequently laminated to the metal foil, natural waxes or synthetic and semisynthetic waxes may nevertheless also be possible, for example polyolefin waxes or polyamide waxes. Combinations of different release agents are also possible.

The release agent coating may be applied by any application method known to the person skilled in the art. For example, it is possible to apply the release agent coating by doctor blading, roller coating, spraying, painting, brushing or the like. Preferably, however, the release agent coating is applied onto the support foil by a plasma method known for example from PTFE coating technology.

The electrolessly and/or electrolytically coatable particles may be particles with any geometry made of any electrolessly and/or electrolytically coatable material, mixtures of different electrolessly and/or electrolytically coatable materials or mixtures of electrolessly and/or electrolytically coatable and non-coatable materials. Suitable electrolessly and/or electrolytically coatable materials are for example carbon, for example carbon black, graphite, graphenes or carbon nanotubes, electrically conductive metal complexes, conductive organic compounds or conductive polymers or metals, preferably zinc, nickel, copper, tin, cobalt, manganese, iron, magnesium, lead, chromium, bismuth, silver, gold, aluminum, titanium, palladium, platinum, tantalum and alloys thereof or metal mixtures which contain at least one of these metals. Suitable alloys are for example CuZn, CuSn, CuNi, CuAg, SnPb, SnBi, SnCo, NiPb, ZnFe, ZnNi, ZnCo and ZnMn. Aluminum, iron, copper, silver, nickel, zinc, tin, carbon and mixtures thereof are particularly preferred.

The electrolessly and/or electrolytically coatable particles preferably have an average particle diameter of from 0.001 to 100 μm, preferably from 0.002 to 50 μm and particularly preferably from 0.005 to 10 μm. The average particle diameter may be determined by means of laser diffraction measurement, for example using a Microtrac X100 device. The distribution of the particle diameters depends on their production method. The diameter distribution typically comprises only one maximum, although a plurality of maxima are also possible. Thus, for example it is possible to mix particles having an average particle diameter of less than 100 nm with particles having an average particle diameter of more than 1 μm, thereby obtaining a denser particle packing.

The surface of the electrolessly and/or electrolytically coatable particles may at least partially be provided with a coating. Suitable coatings may be inorganic (for example SiO₂, phosphates) or organic in nature. The electrically conductive particles may of course also be coated with a metal or metal oxide. The metal may also be present in a partially oxidized form.

If two or more different metals are intended to form the electrolessly and/or electrolytically coatable particles, then this may be done using a mixture of these metals. In particular, it is preferable for the metals to be selected from the group consisting of aluminum, iron, copper, silver, nickel, zinc and tin.

The electrolessly and/or electrolytically coatable particles may nevertheless also comprise a first metal and a second metal, in which the second metal is present in the form of an alloy (with the first metal or one or more other metals), or the electrolessly and/or electrolytically coatable particles may comprise two different alloys.

Besides the choice of the electrolessly and/or electrolytically coatable particles, the shape of the electrolessly and/or electrolytically coatable particles also has an effect on the properties of the dispersion after coating. In respect of the shape, numerous variants known to the person skilled in the art are possible. The shape of the electrolessly and/or electrolytically coatable particles may, for example, be needle-shaped, cylindrical, platelet-shaped or spherical. These particle shapes represent idealized shapes and the actual shape may differ more or less strongly therefrom, for example owing to production. For example, teardrop-shaped particles are a real deviation from the idealized spherical shape in the scope of the present invention.

Electrolessly and/or electrolytically coatable particles with various particle shapes are commercially available.

When mixtures of electrolessly and/or electrolytically coatable particles are used, the individual mixing partners may also have different particle shapes and/or particle sizes. It is also possible to use mixtures of only one type of electrolessly and/or electrolytically coatable particles with different particle sizes and/or particle shapes. In the case of different particle shapes and/or particle sizes, the metals aluminum, iron, copper, silver, nickel, zinc and tin as well as carbon are likewise preferred.

As already mentioned above, the electrolessly and/or electrolytically coatable particles may be added in the form of powder to the dispersion. Such powders, for example metal powders, are commercially available goods and may readily be produced by means of known methods, for instance by electrolytic deposition or chemical reduction from solutions of metal salts or by reduction of an oxidic powder, for example by means of hydrogen, by spraying or atomizing a metal melt, particularly into coolants, for example gases or water. Gas and water atomization and the reduction of metal oxides are preferred. Metal powders with the preferred particle size may also be produced by grinding normal coarser metal powder. A ball mill, for example, is suitable for this. Besides gas and water atomization, the carbonyl-iron powder process for producing carbonyl-iron powder is preferred in the case of iron. This is done by thermal decomposition of iron pentacarbonyl. It is described, for example, in Ullman's Encyclopedia of Industrial Chemistry, 5th Edition, Vol. A14, p. 599. The decomposition of iron pentacarbonyl may, for example, take place at elevated temperatures and elevated pressures in a heatable decomposer that comprises a tube of a refractory material such as quartz glass or V2A steel in a preferably vertical position, which is enclosed by a heating instrument, for example consisting of heating baths, heating wires or a heating jacket through which a heating medium flows. Carbonyl-nickel powder can also be produced by a similar process.

Platelet-shaped electrolessly and/or electrolytically coatable particles can be controlled by optimized conditions in the production process or obtained afterward by mechanical treatment, for example by treatment in an agitator ball mill.

Expressed in terms of the total weight of the dried coating, the proportion of electrolessly and/or electrolytically coatable particles preferably lies in the range of from 20 to 98 wt. %. A preferred range for the proportion of the electrolessly and/or electrolytically coatable particles is from 30 to 95 wt. %, expressed in terms of the total weight of the dried coating. Suitable as a matrix material, for example, are binders with a pigment-affine anchor group, natural and synthetic polymers and derivatives thereof, natural resins as well as synthetic resins and derivatives thereof, natural rubber, synthetic rubber, proteins, cellulose derivatives, drying and non-drying oils and the like. They may—but need not—be chemically or physically curing, for example air-curing, radiation-curing or temperature-curing.

The matrix material is preferably a polymer or polymer blend.

Polymers preferred as a matrix material are, for example, ABS (acrylonitrile-butadiene-styrene); ASA (acrylonitrile-styrene acrylate); acrylic acrylates; alkyd resins; alkyl vinyl acetates; alkyl vinyl acetate copolymers, in particular methylene vinyl acetate, ethylene vinyl acetate, butylene vinyl acetate; alkylene vinyl chloride copolymers; amino resins; aldehyde and ketone resins; celluloses and cellulose derivatives, in particular hydroxyalkyl celluloses, cellulose esters such as acetates, propionates, butyrates, carboxyalkyl celluloses, cellulose nitrate; epoxy acrylate; epoxy resins; modified epoxy resins, for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers, ethylene-acrylic acid copolymers; hydrocarbon resins; MABS (transparent ABS also containing acrylate units); melamine resins, maleic acid anhydride copolymers; methacrylates; natural rubber; synthetic rubber; chlorine rubber; natural resins; colophonium resins; shellac; phenolic resins; phenoxy resins, polyesters; polyester resins such as phenyl ester resins; polysulfones; polyether sulfones; polyamides; polyimides; polyanilines; polypyrroles; polybutylene terephthalate (PBT); polycarbonate (for example Makrolon® from Bayer AG); polyester acrylates; polyether acrylates; polyethylene; polyethylene thiophene; polyethylene naphthalates; polyethylene terephthalate (PET); polyethylene terephthalate glycol (PETG); polypropylene; polymethyl methacrylate (PMMA); polyphenylene oxide (PPO); polystyrenes (PS), polytetrafluoroethylene (PTFE); polytetrahydrofuran; polyethers (for example polyethylene glycol, polypropylene glycol), polyvinyl compounds, in particular polyvinyl chloride (PVC), PVC copolymers, PVdC, polyvinyl acetate as well as copolymers thereof, optionally partially hydrolyzed polyvinyl alcohol, polyvinyl acetals, polyvinyl acetates, polyvinyl pyrrolidone, polyvinyl ethers, polyvinyl acrylates and methacrylates in solution and as a dispersion as well as copolymers thereof, polyacrylates and polystyrene copolymers, for example polystyrene maleic acid anhydride copolymers; polystyrene (modified or not to be shockproof); polyurethanes, uncrosslinked or crosslinked with isocyanates; polyurethane acrylate; styrene acrylic copolymers; styrene-butadiene block copolymers (for example Styroflex® or Styrolux® from BASF AG, K-Resin™ from CPC); proteins, for example casein; styrene-isoprene block copolymers; triazine resins, bismaleimide-triazine resin (BT), cyanate ester resin (CE), allylated polyphenylene ethers (APPE). Mixtures of two or more polymers may also form the matrix material.

Polymers particularly preferred as a matrix material are acrylates, acrylate resins, cellulose derivatives, methacrylates, methacrylate resins, melamine and amino resins, polyalkylenes, polyimides, epoxy resins, modified epoxy resins, for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers and phenolic resins, polyurethanes, polyesters, polyvinyl acetals, polyvinyl acetates, polystyrenes, polystyrene copolymers, polystyrene acrylates, styrene-butadiene block copolymers, triazine resins, bismaleimide-triazine resins (BT), alkylene vinyl acetates and vinyl chloride copolymers, polyamides and copolymers thereof. Mixtures of two or more of these polymers may also form the matrix material.

If the polymer-coated metal foil is used for the production of printed circuit boards, it is preferable to use, as matrix material for the dispersion, thermally or radiation-curing polymers, for example modified epoxy resins such as bifunctional or polyfunctional Bisphenol A or Bisphenol F resins, epoxy-novolak resins, brominated epoxy resins, cycloaliphatic epoxy resins; aliphatic epoxy resins, glycidyl ethers, cyanate esters, vinyl ethers, phenolic resins, phenoxy resins, allylated polyphenylene ethers (APPS), triazine resins, bismaleimide-triazine resins (BT), polyimides, melamine resins and amino resins, polyurethanes, polyesters and cellulose derivatives. Furthermore, mixtures of two or more of these polymers can form the matrix material.

The matrix material may for example furthermore comprise crosslinkers and catalysts known to the person skilled in the art, for example photoinitiators, tertiary amines, imidazoles, aliphatic and aromatic polyamines, polyamidoamines, anhydrides, BF₃-MEA, phenolic resins, styrene-maleic anhydride polymers, hydroxyacrylates, dicyandiamide, or polyisocyanates.

Expressed in terms of the total weight of the dry coating, the proportion of the organic binder components is from 0.01 to 60 wt. %. The proportion is preferably from 0.1 to 45 wt. %, more preferably from 0.5 to 35 wt. %.

In order to be able to apply the dispersion comprising the electrolessly and/or electrolytically coatable particles and the matrix material onto the support foil, a solvent or a solvent mixture may furthermore be added to the dispersion in order to adjust the viscosity of the dispersion suitable for the respective application method. Suitable solvents are, for example, aliphatic and aromatic hydrocarbons (for example n-octane, cyclohexane, toluene, xylene), alcohols (for example methanol, ethanol, 1-propanol, 2-propanol, 1-butanol, 2-butanol, amyl alcohol), polyvalent alcohols such as glycerol, ethylene glycol, propylene glycol, neopentyl glycol, alkyl esters (for example methyl acetate, ethyl acetate, propyl acetate, butyl acetate, isobutyl acetate, isopropyl acetate, 3-methyl butanol), alkoxy alcohols (for example methoxypropanol, methoxybutanol, ethoxypropanol), alkyl benzenes (for example ethyl benzene, isopropyl benzene), butyl glycol, dibutyl glycol, alkyl glycol acetates (for example butyl glycol acetate, dibutyl glycol acetate) dimethyl formamide (DMF), diacetone alcohol, diglycol dialkyl ethers, diglycol monoalkyl ethers, dipropylene glycol dialkyl ethers, dipropylene glycol monoalkyl ethers, diglycol alkyl ether acetates, dipropylene glycol alkyl ether acetate, dioxane, dipropylene glycol and ethers, diethylene glycol and ethers, DBE (dibasic esters), ethers (for example diethyl ether, tetrahydrofuran), ethylene chloride, ethylene glycol, ethylene glycol acetate, ethylene glycol dimethyl ester, cresol, lactones (for example butyrolactone), ketones (for example acetone, 2-butanone, cyclohexanone, methyl ethyl ketone (MEK), methyl isobutyl ketone (MIBK)), dimethyl glycol, methylene chloride, methylene glycol, methylene glycol acetate, methyl phenol (ortho-, meta-, para-cresol), pyrrolidones (for example N-methyl-2-pyrrolidone), propylene glycol, propylene carbonate, carbon tetrachloride, toluene, trimethylol propane (TMP), aromatic hydrocarbons and mixtures, aliphatic hydrocarbons and mixtures, alcoholic monoterpenes (for example terpineol), water and mixtures of two or more of these solvents.

Preferred solvents are alcohols (for example ethanol, 1-propanol, 2-propanol, butanol), alkoxyalcohols (for example methoxy propanol, ethoxy propanol, butyl glycol, dibutyl glycol), butyrolactone, diglycol dialkyl ethers, diglycol monoalkyl ethers, dipropylene glycol dialkyl ethers, dipropylene glycol monoalkyl ethers, propylene glycol monoalkyl ethers, esters (for example ethyl acetate, butyl acetate, butyl glycol acetate, dibutyl glycol acetate, diglycol alkyl ether acetates, dipropylene glycol alkyl ether acetates, propylene glycol alkyl ether acetate, DBE), ethers (for example tetrahydrofuran), polyvalent alcohols such as glycerol, ethylene glycol, propylene glycol, neopentyl glycol, ketones (for example acetone, methyl ethyl ketone, methyl isobutyl ketone, cyclohexanone), hydrocarbons (for example cyclohexane, ethyl benzene, toluene, xylene), DMF, N-methyl-2-pyrrolidone, water and mixtures thereof.

In the case of liquid matrix materials (for example liquid epoxy resins, acrylic esters), the respective viscosity may alternatively be adjusted via the temperature during application, or via a combination of a solvent and temperature.

The dispersion may furthermore comprise a dispersant component. This consists of one or more dispersants.

In principle, all dispersants known to the person skilled in the art for application in dispersions and described in the prior art are suitable. Preferred dispersants are surfactants or surfactant mixtures, for example anionic, cationic, amphoteric or nonionic surfactants.

Cationic and anionic surfactants are described, for example, in “Encyclopedia of Polymer Science and Technology”, J. Wiley & Sons (1966), Vol. 5, pp. 816-818, and in “Emulsion Polymerisation and Emulsion Polymers”, ed. P. Lovell and M. El-Asser, Wiley & Sons (1997), pp. 224-226.

It is nevertheless also possible to use polymers known to the person skilled in the art having pigment-affine anchor groups as dispersants.

The dispersant may be used in the range of from 0.01 to 50 wt. %, expressed in terms of the total weight of the dispersion. The proportion is preferably from 0.1 to 25 wt. %, particularly preferably from 0.2 to 10 wt. %.

The dispersion according to the invention may furthermore comprise a filler component. This may consist of one or more fillers. For instance, the filler component of the metallizable mass may comprise fillers in fiber, layer or particle form, or mixtures thereof. These are preferably commercially available products, for example mineral fillers.

It is furthermore possible to use fillers or reinforcers such as glass powder, mineral fibers, whiskers, aluminum hydroxide, metal oxides such as aluminum oxide or iron oxide, mica, quartz powder, calcium carbonate, magnesium silicate (talc), barium sulfate, titanium dioxide or wollastonite.

Other additives may furthermore be used, such as thixotropic agents, for example silica, silicates, for example aerosils or bentonites, or organic thixotropic agents and thickeners, for example polyacrylic acid, polyurethanes, hydrated castor oil, dyes, fatty acids, fatty acid amides, plasticizers, networking agents, defoaming agents, lubricants, desiccants, crosslinkers, photoinitiators, sequestrants, waxes, pigments, conductive polymer particles.

The proportion of the filler component is preferably from 0.01 to 50 wt. %, expressed in terms of the total weight of the dry coating. From 0.1 to 30 wt. % are further preferred, and from 0.3 to 20 wt. % are particularly preferred.

There may furthermore be processing auxiliaries and stabilizers in the dispersion according to the invention, such as UV stabilizers, lubricating agents, corrosion inhibitors and flame retardants. Their proportion is usually from 0.01 to 5 wt. %, expressed in terms of the total weight of the dispersion. The proportion is preferably from 0.05 to 3 wt. %.

After having applied the base layer onto the support foil with the dispersion, which comprises the electrolessly and/or electrolytically coatable particles in the matrix material, the matrix material is at least partially cured and/or at least partially dried. The drying and/or curing is carried out according to conventional methods. For example, the matrix material may be cured chemically, for example by polymerization, polyaddition or polycondensation of the matrix material, for example by UV radiation, electron radiation, electrowave radiation, IR radiation or temperature, or dried purely chemically by evaporating the solvent. A combination of drying by physical and chemical means is also possible.

By using particles with an average diameter of less than 100 nm, it is preferred to carry out an additional temperature treatment after applying and drying of the layer to sinter the particles together. This temperature treatment is carried out in general at temperatures in the range from 80 to 300° C., preferably in the range from 100 to 250° C. and particularly in the range from 120 to 200° C. in a time period in the range from 1 to 60 min, preferably from 2 to 30 min and particularly from 4 to 15 min.

In one embodiment, the electrolessly and/or electrolytically coatable particles present in the dispersion are at least partially exposed after the at least partial drying or curing, so that electrolessly and/or electrolytically coatable nucleation sites are already obtained, onto which the metal ions can be deposited to form a metal layer during the subsequent electroless and/or electrolytic coating. If the particles consist of materials which are readily oxidized, it is sometimes also necessary to remove the oxide layer at least partially beforehand. Depending on the way in which the method is carried out, for example when using acidic electrolyte solutions, the removal of the oxide layer may already take place simultaneously as the metallization is carried out, without an additional process step being necessary.

An advantage of exposing the particles before the electroless and/or electrolytic coating is that in order to obtain a continuous electrically conductive surface, by exposing the particles the coating only needs to contain a proportion of electrolessly and/or electrolytically coatable particles which is about 5 to 15 wt. % lower than is the case when the particles are not exposed. Further advantages are the homogeneity and continuity of the coatings being produced and the high process reliability.

The electrolessly and/or electrolytically coatable particles may be exposed either mechanically, for example by crushing, grinding, milling, sand-blasting or spraying with supercritical carbon dioxide, physically, for example by heating, laser, UV light, corona or plasma discharge, or chemically. In the case of chemical exposure, it is preferable to use a chemical or chemical mixture which is compatible with the matrix material. In the case of chemical exposure, either the matrix material may be at least partially dissolved on the surface and washed away, for example by a solvent on the surface, or the chemical structure of the matrix material may be at least partially disrupted by means of suitable reagents so that the electrolessly and/or electrolytically coatable particles are exposed. Reagents which make the matrix material tumesce are also suitable for exposing the electrolessly and/or electrolytically coatable particles. The tumescence creates cavities which the metal ions to be deposited can enter from the electrolyte solution, so that a larger number of electrolessly and/or electrolytically coatable particles can be metallized. The process rate of the metallization is also higher because of the larger number of exposed electrolessly and/or electrolytically coatable particles, so that additional cost advantages can be achieved.

If the matrix material is for example an epoxy resin, a modified epoxy resin, an epoxy-novolak, a polyacrylate, ABS, a styrene-butadiene copolymer or a polyether, the electrolessly and/or electrolytically coatable particles are preferably exposed by using an oxidizing agent. The oxidizing agent breaks bonds of the matrix material, so that the binder can be dissolved and the particles can thereby be exposed. Suitable oxidizing agents are, for example, manganates such as for example potassium permanganate, potassium manganate, sodium permanganate, sodium manganate, hydrogen peroxide, oxygen, oxygen in the presence of catalysts such as for example manganese salts, molybdenum salts, bismuth salts, tungsten salts and cobalt salts, ozone, vanadium pentoxide, selenium dioxide, ammonium polysulfide solution, sulfur in the presence of ammonia or amines, manganese dioxide, potassium ferrate, dichromate/sulfuric acid, chromic acid in sulfuric acid or in acetic acid or in acetic anhydride, nitric acid, hydroiodic acid, hydrobromic acid, pyridinium dichromate, chromic acid-pyridine complex, chromic acid anhydride, chromium(VI) oxide, periodic acid, lead tetraacetate, quinone, methylquinone, anthraquinone, bromine, chlorine, fluorine, iron(III) salt solutions, disulfate solutions, sodium percarbonate, salts of oxohalic acids such as for example chlorates or bromates or iodates, salts of perhalic acids such as for example sodium periodate or sodium perchlorate, sodium perborate, dichromates such as for example sodium dichromate, salts of persulfuric acids such as potassium peroxodisulfate, potassium peroxomonosulfate, pyridinium chlorochromate, salts of hypohalic acids, for example sodium hypochloride, dimethyl sulfoxide in the presence of electrophilic reagents, tert-butyl hydroperoxide, 3-chloroperbenzoate, 2,2-dimethylpropanal, Des-Martin periodinane, oxalyl chloride, urea hydrogen peroxide adduct, urea hydrogen peroxide, 2-iodoxybenzoic acid, potassium peroxomonosulfate, m-chloroperbenzoic acid, N-methylmorpholine-N-oxide, 2-methylprop-2-yl hydroperoxide, peracetic acid, pivaldehyde, osmium tetraoxide, oxone, ruthenium(III) and (IV) salts, oxygen in the presence of 2,2,6,6-tetramethylpiperidinyl-N-oxide, triacetoxiperiodinane, trifluoroperacetic acid, trimethyl acetaldehyde, ammonium nitrate. The temperature during the process may optionally be increased in order to improve the exposure process.

Preferred are manganates, for example potassium permanganate, potassium manganate, sodium permanganate; sodium manganate, hydrogen peroxide, N-methylmorpholine-N-oxide, percarbonates, for example sodium or potassium percarbonate, perborates, for example sodium or potassium perborate; persulfates, for example sodium or potassium persulfate; sodium, potassium and ammonium peroxodi- and monosulfates, sodium hydrochloride, urea hydrogen peroxide adducts, salts of oxohalic acids such as for example chlorates or bromates or iodates, salts of perhalic acids such as for example sodium periodate or sodium perchlorate, tetrabutylammonium peroxidisulfate, quinone, iron(III) salt solutions, vanadium pentoxide, pyridinium dichromate, hydrochloric acid, bromine, chlorine, dichromates.

Particularly preferred are potassium permanganate, potassium manganate, sodium permanganate, sodium manganate, hydrogen peroxide and its adducts, perborates, percarbonates, persulfates, peroxodisulfates, sodium hypochloride and perchlorates.

In order to expose the electrolessly and/or electrolytically coatable particles in a matrix material which comprises for example ester structures such as polyester resins, polyester acrylates, polyether acrylates, polyester urethanes, it is preferable for example to use acidic or alkaline chemicals and/or chemical mixtures. Preferred acidic chemicals and/or chemical mixtures are, for example, concentrated or dilute acids such as hydrochloric acid, sulfuric acid, phosphoric acid or nitric acid. Organic acids such as formic acid or acetic acid may also be suitable, depending on the matrix material. Suitable alkaline chemicals and/or chemical mixtures are, for example, bases such as sodium hydroxide, potassium hydroxide, ammonium hydroxide or carbonates, for example sodium carbonate or potassium carbonate.

The temperature during the process may optionally be increased in order to improve the exposure process.

Solvents may also be used to expose the electrolessly and/or electrolytically coatable particles in the matrix material. The solvent must be adapted to the matrix material, since the matrix material must dissolve in the solvent or be tumesced by the solvent. When using a solvent in which the matrix material dissolves, the base layer is brought in contact with the solvent only for a short time so that the upper layer of the matrix material is solvated and thereby dissolved. Preferred solvents are xylene, toluene, halogenated hydrocarbons, acetone, methyl ethyl ketone (MEK), methyl isobutyl ketone (MIBK), diethylene glycol monobutyl ether. The temperature during the dissolving process may optionally be increased in order to improve the dissolving behavior.

Furthermore, it is also possible to expose the electrolessly and/or electrolytically coatable particles by using a mechanical method. Suitable mechanical methods are, for example, crushing, grinding, polishing with an abrasive or pressure spraying with a water jet, sandblasting or spraying with supercritical carbon dioxide. The top layer of the cured base layer is respectively removed by such a mechanical method. The electrolessly and/or electrolytically coatable particles present in the matrix material are thereby exposed.

All abrasives known to the person skilled in the art may be used as abrasives for polishing. A suitable abrasive is, for example, pumice powder. In order to remove the top layer of the cured dispersion by pressure blasting, the water jet preferably contains small solid particles, for example pumice powder (Al₂O₃) with an average particle size distribution of from 40 to 120 μm, preferably from 60 to 80 μm, as well as quartz powder (SiO₂) with a particle size >3 μm.

If the electrolessly and/or electrolytically coatable particles comprise a material which is readily oxidized, in a preferred method variant the oxide layer is at least partially removed before the metal layer is formed on the structured or surface-wide base layer. The oxide layer may in this case be removed chemically and/or mechanically, for example. Suitable substances with which the base layer can be treated in order to chemically remove an oxide layer from the electrolessly and/or electrolytically coatable particles are, for example, acids such as concentrated or dilute sulfuric acid or concentrated or dilute hydrochloric acid, citric acid, phosphoric acid, amidosulfonic acid, formic acid, acetic acid.

Suitable mechanical methods for removing the oxide layer from the electrolessly and/or electrolytically coatable particles are generally the same as the mechanical methods for exposing the particles.

The base layer is preferably applied with the dispersion by a conventional and widely known coating method. Such coating methods are for example casting, painting, doctor blading, spraying, immersion, roller coating, powdering or the like. As an alternative, it is also possible to print the base layer onto the support foil by any printing method. The printing method with which the base layer is printed is, for example, a roll or a sheet printing method such as for example screen printing, intaglio printing, flexographic printing, typography, pad printing, inkjet printing, the Lasersonic® method as described for example in DE-A 100 51 850, offset printing or magnetographic printing methods. Any other printing method known to the person skilled in the art may, however, also be used. The layer thickness of the base layer, produced by the coating method or by the printing, preferably varies between 0.01 and 50 μm, more preferably between 0.05 and 25 μm and particularly preferably between 0.1 and 15 μm. The layers may be applied in a surface-wide or structured manner. A plurality of layers may also be applied in succession.

Differently fine structures can be printed directly, depending on the printing method.

The dispersion is preferably stirred or pumped around in a storage container before application to the support foil. Stirring and/or pumping prevents possible sedimentation of the particles present in that dispersion. Furthermore, it is likewise advantageous for the dispersion to be thermally regulated in the storage container. This makes it possible to achieve an improved printing impression of the base layer on the support foil, since a constant viscosity can be adjusted by thermal regulation.

Thermal regulation is necessary in particular whenever, for example, the dispersion is heated by the energy input of the stirrer or pump when stirring and/or pumping and its viscosity therefore changes. In order to increase the flexibility and for cost reasons, digital printing methods, for example inkjet printing, or laser methods such as LaserSonic® are particularly suitable in the case of structured application of the dispersion and in the case of frequent layout changes. These methods generally obviate the costs for the production of structured application of the dispersion and in the case of frequent layout changes, for example printing rolls or screens, as well as their constant changing when a plurality of different structures need to be printed successively. In digital printing methods, it is possible to change over to a new design immediately, without refitting times and stoppages. When structured printing is intended to be carried out constantly with the same layouts, the conventional printing methods such as intaglio, flexographic, screen printing or magnetographic printing methods are preferred.

In the case of application of the dispersion by means of the inkjet methods, it is preferable to use electrolessly and/or electrolytically coatable particles with a maximum size of 10 μm, particularly preferably <5 μm, in order to prevent blockage of the inkjet nozzles. To avoid sedimentation in the inkjet head, the dispersion can be circulated by pumping, using a pumped-circulation circuit, to prevent the particles from settling. It is moreover advantageous that the system can be heated, in order to adjust the viscosity of the dispersion for printing purposes.

The dispersion which has been applied and, if appropriate, at least partially dried and/or at least partially cured is coated in a further step, electrolessly and/or electrolytically.

The electroless and/or electrolytic coating may in this case be carried out using any method known to the person skilled in the art. Any conventional metal coating may moreover be applied. In this case the composition of the electrolyte solution which is used for the coating depends on the metal which is intended to be applied to the base layer. Conventional metals which are deposited onto the electrolessly and/or electrolytically coatable surfaces by electroless and/or electrolytic coating are, for example, gold, nickel, palladium, platinum, silver, tin, copper or chromium. The thicknesses of the one or more deposited layers lie in the conventional range known to the person skilled in the art. In the case of electroless coating, all metals which are nobler than the least noble metal of the dispersion may be used.

Suitable electrolyte solutions, which are used for coating electrically conductive structures, are known to the person skilled in the art for example from Werner Jillek, Gustl Keller, Handbuch der Leiterplattentechnik [Handbook of printed circuit technology], Eugen G. Leuze Verlag, 2003, volume 4, pages 332-352.

In the case of the electrolytic coating, for example, in order to produce the metal layer, in general the support foil coated with the dispersion is first sent to a bath of the electrolyte solution. The support foil is then transported through the bar, the electrolessly and/or electrolytically coatable particles contained in the previously applied base layer being contacted by at least one cathode. Here, any suitable conventional cathode known to the person skilled in the art may be used. For as long as the cathode contacts the base layer, metal ions are deposited from the electrolyte solution to form a metal layer on the base layer.

In order to be able to apply the base layer, provided with the metal layer, to a printed circuit board support, for example a polymer is finally applied to the metal layer. The polymer is applied by any application method known to the person skilled in the art. Suitable application methods are for example painting, spraying, doctor blading, casting, roller application, immersion, extrusion or printing.

The polymer has the task of secure adhesive bonding of the metal foil to the printed circuit board support.

After application of the polymer to the metal layer, the polymer can be at least partially dried and/or cured. The drying and/or curing here takes place by a method identical with that described above for the matrix material.

In order to permit lamination of the support foil with the metal layer and with the polymer applied thereto to a surface, it is preferable, in the case of curing polymers, that the polymer retains some residual flowability. For this reason, the partial curing is carried out in such a way that polymerization of the polymer does not proceed to completion.

Preferred polymers which are applied to the metal layer are acrylates, acrylate resins, cellulose derivatives, methacrylates, methacrylate resins, melamine and amino resins, polyalkylenes, polyimides, epoxy resins, modified epoxy resins, e.g. bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers, phenolic resins, polyurethanes, polyesters, polyvinyl acetals, polyvinyl acetates and the corresponding copolymers, polystyrenes, polystyrene copolymers, polystyrene acrylates, styrene-butadiene block copolymers, alkylene vinyl acetates and vinyl chloride copolymers, polyamides, and also their copolymers, phenoxy resins, triazine resins, bismaleimide-triazine resins (BT), allylated polyphenylene ethers (APPE) and fluoro resins. It is also possible to use mixtures of two or more of these polymers.

If the polymer-coated metal foil is used for the production of printed circuit boards, polymers used are preferably thermally or radiation-curing polymers, e.g. modified epoxy resins, such as bifunctional or polyfunctional Bisphenol A resins or bifunctional or polyfunctional Bisphenol F resins, or epoxy-novolak resins, brominated epoxy resins, cycloaliphatic epoxy resins; aliphatic epoxy resins, glycidyl ethers, cyanate esters, vinyl ethers, phenolic resins, polyimides, melamine resins and amino resins, triazine resins, bismaleimide-triazine resins, phenoxy resins, polyurethanes, polyesters, and also cellulose derivatives. It is also possible to use mixtures of two or more of these polymers. The polymer can moreover comprise the additions described above for the matrix material, for example solvents, additives, such as adhesion promoters, crosslinking agents and catalysts, e.g. photoinitiators, tertiary amines, imidazoles, aliphatic and aromatic polyamines, polyamidoamines, anhydrides, BF₃-MEA, phenolic resins, styrene-maleic anhydride polymers, hydroxyacrylates, dicyandiamide or polyisocyanates, and also flame retardants and fillers, for example fillers of inorganic type, such as phyllosilicates, aluminum oxides, magnesium silicate (talc) or glass, in appropriate amounts.

In order to improve the adhesion of the applied polymer layer on the metal layer, the metal layer can, if required, be provided with an additional adhesion layer prior to the application of the polymer. The additional adhesion layer is applied by methods known to the person skilled in the art. The adhesion promoter used can, for example, be what are known as black oxides or brown oxides based on NaClO₂/NaOH, or commercially available adhesion promoters, for example based on H₂SO₄/H₂O₂, or can be silanes, or else polyethyleneimine solutions, for example the Lupasol grades from BASF AG.

The polymer applied to the metal layer permits easy lamination of the metal foil thus produced, for example to a support. This can take place on one side or on both sides.

According to the invention, the foil is used, for example, for the production of printed circuit boards. To this end, the support foil with the metal layer and with the polymer applied thereto is laminated to a support. To this end, the polymer side of polymer-coated metal foil is applied, for example, to a structured inner ply provided with conductor tracks, or, respectively, on a stack composed of inner plies provided with conductor tracks and of prepregs arranged in alternating mutual superposition (subcomposite). Multi-ply printed circuit boards can thus be produced via processes known to the person skilled in the art. It is also possible, if required, that a plurality of these polymer-coated metal foils are applied in succession, where, after application of the polymer-coated metal foil, the metal surface is structured with conductor tracks using processes known to the person skilled in the art, and further processed, before the next polymer-coated metal foil is applied. The use of the thin copper layer as base for the conductor track structuring provides the advantage, in comparison with conventional conductor track construction methods, that, after the electroless and/or electrolytic coating to the user-specific layer, generally from 12 to 35 μm, by means of a photoresist-masked coppering process, there remains only the thin base layer to be back-etched. Since the previously formed conductor track structures are also concomitantly back-etched during this back-etching process, the thin copper base layer achieves a large gain in structure resolution for very fine conductor technology. Furthermore, significantly less copper-containing waste is produced, since the copper layers that have to be back-etched are relatively thin.

The support is generally an electrically nonconductive material. However, it is possible that one or more structured metallic layers have previously been applied to the electrically nonconductive material. The individual metallic layers serve, for example, as conductor tracks. Between the metallic layers there is in each case a polymer layer. Each of the individual metallic layers can, for example, be produced via application of a polymer-coated metal foil.

The electrically nonconductive base material of the support is mostly previously fully cured material. Because of the polymer which has been applied to the metal layer and has not yet been cured, it is possible to achieve good bonding of the metal layer to the mostly fully cured plastics material of the support.

Another possibility, alongside application of the polymer-coated metal foil to one side of the support, is to provide both sides of the support with a polymer-coated metal foil. In this case, the inventively produced, polymer-coated metal foil is laminated to both the upper side and the underside of the support.

After application of the polymer-coated metal foil to the support, this “subcomposite” is generally pressed at an elevated temperature. The temperature preferably lies in the range of from 120 to 250° C.

The pressure, with which the subcomposite is pressed, preferably lies in the range of from 0.1 to 100 bar, particularly in the range of from 5 to 40 bar.

The duration for which the curing is carried out to form the laminate with metal coating on one or more sides generally lies in the range of from 1 to 360 minutes, preferably in the range of from 15 to 220 minutes and particularly preferably in the range of from 30 to 90 minutes.

A suitable base material for the support is for example any reinforced or unreinforced polymer, such as is conventionally used for printed circuit boards. Suitable polymers are for example bifunctional or polyfunctional epoxy resins based on Bisphenol A or on Bisphenol F, brominated epoxy resins, cycloaliphatic epoxy resins, epoxy-novolaks, bismaleimide-triazine resins, polyimides, phenolic resins, cyanate esters, melamine resins or amino resins, phenoxy resins, allylated polyphenylene ethers (APPE), polysulfones, polyamides, silicone and fluorine resins and combinations thereof. The material for the support may for example furthermore comprise additives known to the person skilled in the art, such as crosslinkers and catalysts, for example tertiary amities, imidazoles, aliphatic and aromatic polyamines, polyamidoamines, anhydrides, BF₃-MEA, phenolic resins or dicyandiamide, as well as flame retardants and fillers, for example fillers of inorganic nature such as phyllosilicates, aluminum oxides or glass.

Furthermore, other polymers conventional in the printed circuit board industry are also suitable. The support here may be rigid or flexible.

For the production of electrical printed circuit boards, reinforced supports are preferably used. Suitable fillers for the reinforcement are for example paper, glass fibers, glass nonwovens, glass fabrics, aramid fibers, aramid nonwovens, aramid fabrics, PTFE fabric, PTFE foil sheet. The base material for the support is preferably glass-fiber-reinforced material.

Depending on the thickness of the metal-coated laminate being produced, it may be rigid or flexible after pressing.

In order to be able to produce a plurality of metal-coated laminates simultaneously, in a preferred embodiment a plurality of plies composed of the support foil with the metal layer applied thereon and the polymer and the support are stacked alternately. Care always has to be taken here that if the intention is to produce laminates provided on both sides with a metal layer, a support foil coated with the polymer and provided with the metal layer is always in contact with the polymer on the upper side and on the underside of the support. Separator sheets can, for example, be inserted between two support foils. This is preferred, for example, when the metal layer applied to the support is to be structured.

The separator sheet has preferably been fabricated from steel.

Another possibility, alongside laminates coated on both sides, is to produce laminates which have been provided with a metal layer only on one side. If the intention is to produce a plurality of laminates each of which has been provided with a metal layer only on one side, the usual method is that a support foil with base layer and metal layer and also with the polymer applied thereto and the support are stacked alternately. The polymer on the support foil here always faces the same direction, namely toward the next support. In this case, too, it is preferable to insert a separator sheet in each case between a support and the support foil which is to be laminated to the next support. It is also possible to structure the metal layer in the case of a single-side metal-coated laminate.

In order to produce the metal-coated laminate, the stack composed of the support foils and of the support is pressed. To this end, for example, the stack is introduced into the opening of a hydraulic press, between the heating and pressure plates, and is processed further according to process sequences known to the person skilled in the art for the conventional fabrication of laminates.

The pressing is conventionally carried out at a pressure in the range of from 0.1 to 100 bar, preferably at a pressure in the range of from 5 to 40 bar. When using base materials for the support which cure with an elevated temperature, the pressing is preferably carried out at elevated temperature. The temperature selected will depend on the material being used. The temperature is preferably from 100 to 300° C., particularly preferably from 120 to 230° C. For example, standard FR4 epoxy resins systems are compressed at from 175 to 180° C. More highly crosslinked systems require up to 225° C. The pressing pressure is preferably selected between 15 bar and 30 bar for such base materials for the support.

During the pressing, the formable base material for the support is preferably cured at least partially. In this way a metal-coated laminate, which can be processed further, will have been formed after the pressing.

The thickness of the support will be set by the amount of the base material for the support, its polymer content and the pressing pressure. The surface quality of the metal-coated laminate produced in this way generally corresponds to the surface condition of the separator sheets placed between the individual support foils and printed circuit board support.

After lamination of the support foil with the base layer, the metal layer and the polymer layer onto the support, the support foil is removed from the base layer. Since the metal layer is applied onto the base layer but has sometimes not fully replaced the dispersion, after the support foil has been removed the upper side of the laminate can have a base layer, which optionally also comprises electrolessly and/or electrolytically coatable particles in at least parts of the matrix material. The polymer-coated side of the polymer-coated metal foil faces the support. In order to achieve a continuous electrically conductive layer on the support in one embodiment, after removing the support foil, in a further step it is preferable to provide that side of the base layer which was covered by the support foil with a further metal layer electrolessly and/or electrolytically. This is done by conventional methods known to the person skilled in the art. Before the electroless and/or electrolytic deposition of metal, the electrolessly and/or electrolytically coatable particles present in the base layer are if appropriate exposed at least partially after removal of the support foil. The electrolessly and/or electrolytically coatable particles are in this case exposed, as described above for the exposure of the electrolessly and/or electrolytically coatable particles of the dispersion which was applied onto the support foil.

Owing to the electroless and/or electrolytic deposition of metal onto that side of the base layer, which was previously covered with the support foil, a continuous electrically conductive metal layer is produced. The metal here is preferably the same as that of the metal layer which faces in the direction of the support.

In another embodiment, the possibly remaining parts of the base layer are removed. To this end, the base layer is subjected to a treatment which corresponds to that described above for exposing the electrolessly and/or electrolytically coatable particles. Like the exposure of the electrolessly and/or electrolytically coatable particles, the removal of the base layer may also be carried out chemically or mechanically. The treatment will be carried out until the base layer is completely removed. In this way the electrolessly and/or electrolytically coatable particles still remaining, which are contained in the layer, are also removed. A pure metal layer, made of the metal which has been applied electrolessly and/or electrolytically, is left remaining.

After pressing and curing the formable electrically nonconductive material and lamination to apply the polymer-coated metal foil, this (metal-coated) laminate is preferably processed further. For example, it is possible to cut the metal-coated laminate to size. To this end, the individual layers may be sliced into plates of predetermined size.

An electrically conductive structure is preferably produced from the applied metal layer. The electrically conductive structure is generally produced by methods known to the person skilled in the art. Suitable methods are for example plasma etching, photoresist methods or laser ablation methods. Furthermore, after this structuring it is also possible to produce blind holes, microvias, etc., for example via laser boring.

If a flexible support is used, it is possible to carry out the inventive method continuously. This then takes place, for example, in a roll-to-roll process in which the support is unwound from a feed roll, passes through at least one processing step, and then is rewound onto a further roll.

The invention will be described in more detail below by way of example with the aid of a drawing, in which:

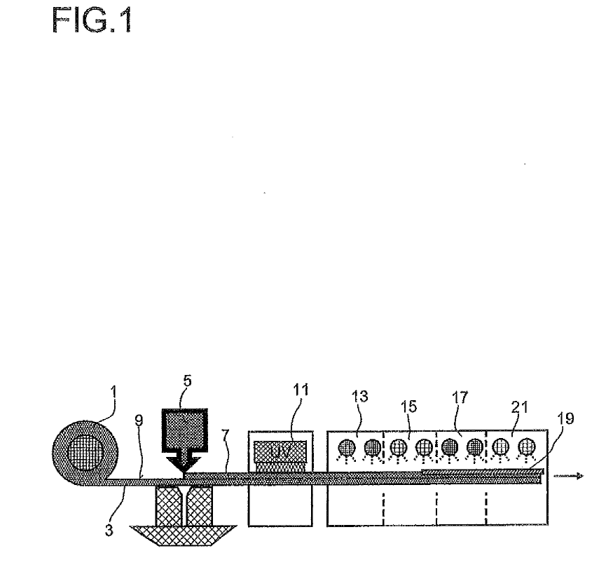

FIG. 1 shows a diagram of application of the dispersion and of the subsequent metallization process,

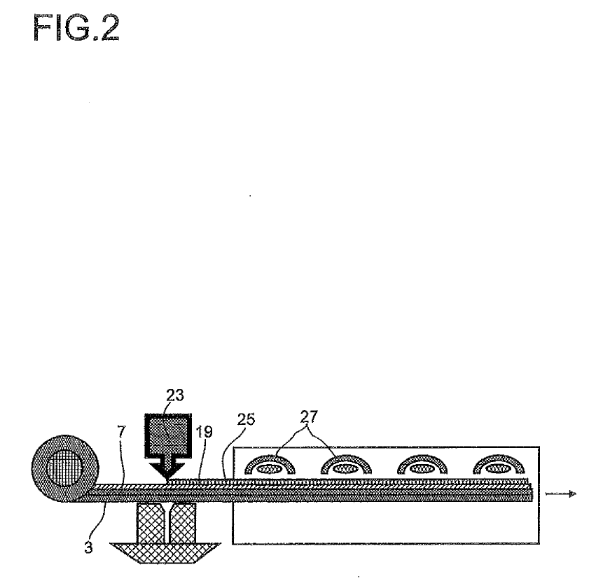

FIG. 2 shows the application of the polymer to the metal layer,

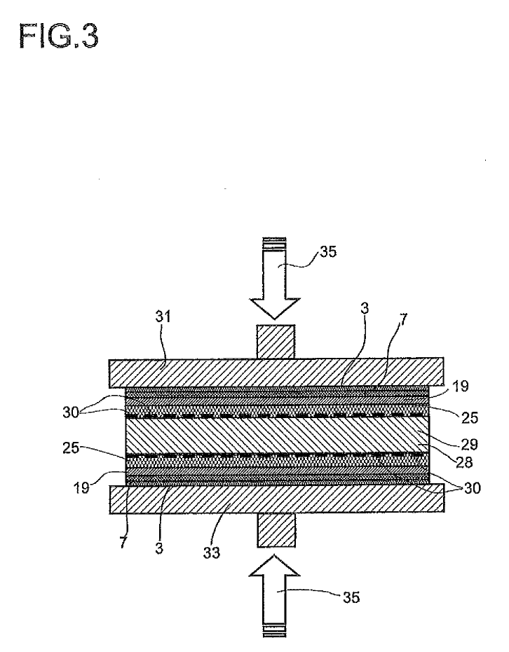

FIG. 3 shows application of the polymer-coated metal foil by lamination to a printed circuit board support, and

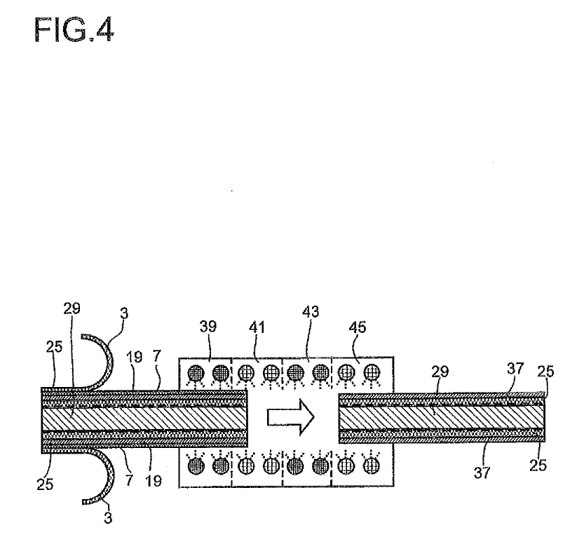

FIG. 4 shows a diagram of metallization of the laminate after the lamination process.

FIG. 1 shows a diagram of the application of a base layer to a support foil and the subsequent metallization of the base layer.

To produce a “continuous” foil, a support foil 3 is unwound from a feed 1. The support foil 3 is, for example, a polymer foil or a metal foil.

A dispersion 5 is applied to the support foil 3. The dispersion 5 comprises electrolessly and/or electrolytically coatable particles in a matrix material. Application of the dispersion 5 to the support foil 3 forms a base layer 7. In order that the support foil 3 can easily be removed subsequently from the base layer 7, the support foil 3 has been provided with an upper side 9 which does not adhere to the base layer 7. This can firstly be ensured in that the upper side 9 has been coated with a release agent. As an alternative, it is also possible that the support foil 3 has been fabricated from a material which has only weak adhesion, or no adhesion at all, to the base layer 7.

Coating processes familiar to the person skilled in the art are used for the structured or full-surface application of the dispersion 5 to form the base layer 7. Coating processes or printing processes known to the person skilled in the art are suitable for this purpose, for example. The dispersion 5 can, for example, therefore be applied via casting, painting, doctor blading, spraying, immersion, roller coating or the like. As an alternative, it is also possible to apply the base layer 7 to the support by printing via any desired printing method.

After application of the dispersion 5 to form the base layer 7 on the support foil 3, the matrix material present in the dispersion 5 is at least partially cured. This takes place, for example, via irradiation with an IR source 11. As an alternative, the matrix material of the dispersion 5 can also be at least partially cured via electron radiation, electrowave radiation, UV radiation, or elevated temperature. Furthermore, it is also possible to carry out purely physical drying of the dispersion 5 via evaporation of the solvent. A combination of physical and chemical drying is also possible.

After at least partially drying and/or at least partially curing the base layer 7, it is possible for the electrolessly and/or electrolytically coatable particles present in the base layer 7 to be at least partially exposed. This is done for example by washing with potassium permanganate. As an alternative, any other of the oxidizing agents or solvents mentioned above may nevertheless also be used for exposing the electrolessly and/or electrolytically coatable particles. The exposure is for example carried out by spraying the base layer 7 with the oxidizing agent, for example potassium permanganate. The exposure of the electrolessly and/or electrolytically coatable particles is carried out in an activation zone 13, and is represented only schematically here. The exposure is followed by a washing process, in order to remove, for example, the residual oxidizing agent or solvent from the support foil 3 coated with the base layer 7. This is done in a washing zone 15, and is likewise represented only schematically here. The washing agent used in the washing zone 15 may, for example, be an aqueous, acidic hydrogen peroxide solution or an acidic hydroxylamine nitrate solution.

After the washing in the washing zone 15, the base layer 7 with the now exposed electrolessly and/or electrolytically coatable particles is coated electrolessly and/or electrolytically with a metal layer 19. This is done in a coating zone 17. The electroless and/or electrolytic coating may in this case be carried out according to any method known to the person skilled in the art. The coating zone 17 is generally followed by a second washing zone 21. In the second washing zone 21, residues of the electrolyte are washed off from the metal layer 19.

The electrolyte solution for the electroless and/or electrolytic coating is not usually sprayed on, as represented here in FIG. 1, rather the support foil 3, which is coated with the base layer 7, is immersed into the electrolyte solution. Nevertheless, any other method known to the person skilled in the art, by which the base layer 7 can be coated electrolessly and/or electrolytically, is also suitable. The electrolessly and/or electrolytically coatable particles in the base layer 7 may also be exposed by immersion in an oxidizing agent or solution. It is also possible to carry out the washing not by spraying onto the support foil 3 but by immersion into a washing solution. Any other method suitable for the person skilled in the art may also be used for exposing the electrolessly and/or electrolytically coatable particles from the base layer 7, and for washing the support foil 3 which is coated with the base layer 7.

After application of the metal layer 19 to the base layer 7 it is, for example, possible to wind up the support foil 3 with the base layer 7 and the metal layer 19, onto a roll. However, it is moreover also possible to introduce the support foil 3 with the base layer 7 and the metal layer 19 directly into a further processing step.

FIG. 2 shows a diagram of application of a polymer to the support foil 3 provided with the metal layer 19 and with the base layer 7.

A polymer 23 is applied to the metal layer 19. The polymer 23 is applied, for example, as for the application of the dispersion 5, via any desired coating method or printing method known to the person skilled in the art. Examples of suitable coating methods are casting, painting, doctor blading, spraying, immersion, roller coating or the like.

The polymer 23, which if required comprises the materials described above which are solvents, fillers, and additives, such as hardeners or catalysts, is applied in the form of a polymer layer 25 to the metal layer 19. After application of the polymer layer 25 it is possible, for example, to cure this at least partially. This is achieved, for example, via irradiation with IR sources 27. As an alternative, the polymer 23 can also be at least partially cured via electron radiation, UV radiation or elevated temperature. Furthermore, it is also possible to carry out purely physical drying of the polymer 23 via evaporation of the solvent. A combination of physical and chemical drying is also possible.

FIG. 3 shows a diagram of application, by lamination, of the support foil 3 coated with the polymer layer 25, with the metal layer 19, and with the base layer 7, to a support 29. The support 29 is, for example, an inner ply for multi-ply printed circuit boards, and comprises, in the embodiment shown here, a base support 28, for example a glass-fiber-reinforced epoxy resin support, for example composed of FR-4 material with applied conductor track structure 30.

In order to provide the support 29 with a metal layer on its upper side and underside, a support foil 3 coated with polymer layer 25, metal layer 19, and base layer 7 is placed on, respectively, the upper side and underside of the support 29 in such a way that the polymer layer 25 faces the support 29. The resultant stack is pressed between an upper ram 31 and a lower ram 33 of a press. An example of a suitable press is a hydraulic press. The arrow 35 symbolizes the application of the pressure. The base support 28 can be a moldable, electrically nonconductive material. If the material of the support 28 is moldable, this is preferably composed of plastics sheets which have not yet been completely cured. These are, for example, cured at an elevated temperature during the pressing process. To this end, it is possible, for example, that either the upper ram 31 or the lower ram 33 of the press is heatable, or that the two rams 31 and 33 are heatable.

Another possibility alongside the production of only one printed circuit board support 29 coated on its upper side and underside to give a metal-coated laminate as shown in FIG. 3 is to stack a plurality of supports 29, each of which has been provided, on its upper side and underside, with a support foil 3 provided with polymer layer 25, metal layer 19 and base layer 7. Separator sheets can be inserted between the individual printed circuit board supports 29 with, applied thereto, support foil 3 with base layer 7, metal layer 19 and polymer layer 25. The separator sheets can, for example, have an intended surface structure, in order to structure the metal layer 19 which is applied by lamination via the pressure procedure to the printed circuit board support.

The step shown by way of example in FIG. 3 can also be carried out in a continuous roll-to-roll method. To this end, one or more support foils 3 provided with polymer layer 25, metal layer 19 and base layer 7 are continuously passed between at least two heated rolls with a support 29 which now, for example, has been fabricated likewise from a continuous foil. The pressure for the pressing process is likewise exerted by way of the rolls. The at least partial curing can, for example, also take place in a downstream curing section. The intermediate product produced can then be further processed either continuously or batchwise.

For production of a metal-coated laminate, the support foil 3 is first removed from the base layer 7 in a step which follows the lamination process. FIG. 4 shows this.

After removal of the support foil 3, there can sometimes be, on the surface of the printed circuit board support 29, residual portions of the base layer 7 composed of matrix material with electrolessly and/or electrolytically coatable particles present therein, In order to produce a continuous metal coating which is electrically conductive, it is necessary that the base layer 7 be provided, after removal of the support foil 3, with a metal layer 37. The metal layer 37 is preferably formed vian electroless and/or electrolytic coating. The electroless and/or electrolytic coating replaces the electrolessly and/or electrolytically coatable particles from the base layer 7 by the coating material. A continuous metal layer 37 forms on the polymer layer 25.

In order to permit coating of any remaining portions of the base layer 7, it is preferable that the electrolessly and/or electrolytically coatable particles present in the base layer 7 are first exposed. This is generally done in a second activation zone 39. As described above, the exposure is in this case carried out for example by treatment with an oxidizing agent or a solvent. Suitable solvents and oxidizing agents have likewise been described above. As an alternative, it is possible to expose the electrolessly and/or electrolytically coatable particles physically or mechanically. If the exposure is carried out chemically, then it is possible to bring the activating agent, for example the oxidizing agent or solvent, in contact with the base layer 7, which comprises the electrolessly and/or electrolytically coatable particles, by spraying. As an alternative, it is also possible to immerse the printed circuit board support 29 with the laminated-on polymer layer 25, metal layer 19 and base layer 7 into the activating agent.

After the electrolessly and/or electrolytically coatable particles have been exposed, residues of the solvent or oxidizing agent are preferably washed off from the base layer 7. This is done for example in a third washing zone 41, which preferably comprises the same washing agents as the washing zone 15. For the washing, the support 29 with the polymer layer 25, the metal layer 19 and the base layer 7, may for example be sprayed with a washing agent, for example water. As an alternative, for example, it is also possible to immerse the support 29 with the applied layers 25, 19 and 7.

The third washing zone 41 is followed by a second coating zone 43, in which the base layer 7 comprising electrolessly and/or electrolytically coatable particles is coated electrolessly and/or electrolytically with the metal layer 37. The electroless and/or electrolytic coating may in this case be carried out in any way known to the person skilled in the art. In general, the electroless and/or electrolytic coating will be carried out as described above.

In order to remove residues of the electrolyte solution from the support 29 coated with the metal layer 37 and the polymer layer 25 after the electroless and/or electrolytic coating, the support 29 with the layers 25, 37 is preferably washed in a fourth washing zone 45 after the electroless and/or electrolytic coating. The washing is generally carried out with water.

In the case of a sufficiently thin base layer 7, which comprises the electrolessly and/or electrolytically coatable particles, it is possible for the electrolessly and/or electrolytically coatable particles present in the base layer 7 to be replaced with metal ions from the electrolyte solution by the electroless and/or electrolytic coating. In this case a continuous metal layer 37 is applied on the polymer layer 25 bonded to the printed circuit board support 29.

The metal layer 37 produced by the method according to the invention generally has a thickness of less than 20 μm, preferably less than 10 μm and particularly preferably less than 5 μm.

After the metal layer has been applied, the metal-coated laminate produced in this way, which comprises the support 29 with the polymer layer 25 and the metal layer 37, may be processed further. This is done, for example, as described above, by general processing methods for printed circuit boards such as are known to the person skilled in the art.

The polymer-coated metal foils according to the invention may be used for example to produce printed circuit boards. Such printed circuit boards are for example those with multilayer inner and outer levels, micro-vias, chip-on-boards, flexible and rigid printed circuit boards, for example installed in products such as computers, telephones, televisions, electrical components of automobiles, keyboards, radios, video, CD, CD-ROM and DVD players, game consoles, measuring and regulating equipment, sensors, electrical kitchen appliances, electrical toys etc.

The polymer-coated metal foils according to the invention may furthermore be used to produce RFID antennas, transponder antennas or other antenna structures, chip card modules, flat cables, seat heaters, foil conductors, conductor tracks in solar cells or in LCD/plasma screens, capacitors, foil capacitors, resistors, convectors, electrical fuses or to produce electrolytically coated products in any form, for example polymer supports clad with metal on one or two sides with a defined layer thickness, 3D molded interconnect devices or to produce decorative or functional surfaces on products, for example to shield against electromagnetic radiation, for thermal conduction or as packaging. Furthermore, the polymer-coated metal foils may also be used to produce contact points or contact pads or interconnections on an integrated electronic component, as well as to produce antennas with contacts for organic electronic components. Use is furthermore possible in the context of flow fields of bipolar plates for application in fuel cells. It is furthermore possible to produce a surface-wide or structured electrically conductive layer for the subsequent decorative metallization of supports, such as, for example, decorative parts for the motor vehicle sector, sanitary sector, toy sector, household sector, and office sector, and packaging, and also foils. It is furthermore possible to produce thin metal foils or polymer supports clad on one or two sides. The polymer-coated metal foils may also be employed in fields for which good thermal conductivity is advantageous, for example in foils for seat heaters, floor heaters and insulating materials.

The polymer-coated metal foils according to the invention are preferably used to produce printed circuit boards, RFID antennas, transponder antennas, seat heaters, flat cables, contactless chip cards, thin metal foils or polymer supports clad on one or two sides, foil conductors, conductor tracks in solar cells or in LCD/plasma screens or to produce decorative products, for example for packaging materials.

### LIST OF REFERENCES

1 store
3 support foil
5 dispersion
7 base layer
9 top
11 IR source
13 activation zone
15 washing zone
17 coating zone
19 metal layer
21 second washing zone
23 polymer
25 polymer layer
27 IR source
28 base support
29 support
30 conductor track structure
31 upper die
33 lower die
37 metal layer
39 second activation zone
41 third washing zone
43 second coating zone
45 fourth washing zone

1.-18. (canceled)

19. A method for producing polymer-coated metal foils, comprising:
(a) applying a base layer 7 onto a support foil 3 using a dispersion 5 which comprises electrolessly and/or electrolytically coatable particles in a matrix material, wherein the support foil 3 is fabricated from a material which adheres weakly to the base layer 7,
(b) at least partially drying and/or at least partially curing the matrix material,
(c) forming a metal layer 19 on the base layer 7 by electroless and/or electrolytic coating of the base layer, and
(d) applying a polymer 23 to the metal layer 19.

20. The method according to claim 19, wherein the electrolessly and/or electrolytically coatable particles present in the base layer 7 are at least partially exposed before the metal layer 19 is formed in step (c).

21. The method according to claim 20, wherein the exposure of the electrolessly and/or electrolytically coatable particles is carried out chemically, physically or mechanically.

22. The method according to claim 20, wherein the exposure of the electrolessly and/or electrolytically coatable particles is carried out with an oxidizing agent, wherein the oxidizing agent is selected from potassium permanganate, potassium manganate, sodium permanganate, sodium manganate, hydrogen peroxide or its adducts, a perborate, a percarbonate, a persulfate, a peroxodisulfate, sodium hypochloride or a perchlorate.

23. The method according to claim 20, wherein the exposure of the electrolessly and/or electrolytically coatable particles is carried out by the action of substances which can dissolve, etch and/or tumesce the matrix material, wherein the substance which can dissolve, etch and/or tumesce the matrix material is an acidic or alkaline chemical or chemical mixture, or a solvent.

24. The method according to claim 19, wherein any existing oxide layer is removed from the electrolessly and/or electrolytically coatable particles before the electroless and/or electrolytic coating in step (c).

25. The method according to claim 19, wherein the metal of the metal layer is copper, nickel, silver, gold or chromium.

26. A method for the production of a metal-coated support, comprising the following steps:
(a) applying a base layer 7 onto a support foil 3 using a dispersion 5 which comprises electrolessly and/or electrolytically coatable particles in a matrix material, wherein the support foil 3 is fabricated from a material which adheres weakly to the base layer 7,
(b) at least partially drying and/or at least partially curing the matrix material,
(c) forming a metal layer 19 on the base layer 7 by electroless and/or electrolytic coating of the base layer,
(d) applying a polymer 23 to the metal layer 19.
(e) laminating the support foil, with the metal layer 19 applied thereto, to a support.

27. The method according to claim 26, wherein the electrolessly and/or electrolytically coatable particles present in the base layer 7 are at least partially exposed before the metal layer 19 is formed in step (c).

28. The method according to claim 27, wherein the exposure of the electrolessly and/or electrolytically coatable particles is carried out chemically, physically or mechanically.

29. The method according to claim 27, wherein the exposure of the electrolessly and/or electrolytically coatable particles is carried out with an oxidizing agent, wherein the oxidizing agent is selected from potassium permanganate, potassium manganate, sodium permanganate, sodium manganate, hydrogen peroxide or its adducts, a perborate, a percarbonate, a persulfate, a peroxodisulfate, sodium hypochloride or a perchlorate.

30. The method according to claim 27, wherein the exposure of the electrolessly and/or electrolytically coatable particles is carried out by the action of substances which can dissolve, etch and/or tumesce the matrix material, wherein the substance which can dissolve, etch and/or tumesce the matrix material is an acidic or alkaline chemical or chemical mixture, or a solvent.

31. The method according to claim 26, wherein any existing oxide layer is removed from the electrolessly and/or electrolytically coatable particles before the electroless and/or electrolytic coating in step (c).

32. The method according to claim 26, wherein the metal of the metal layer is copper, nickel, silver, gold or chromium.

33. The method according to claim 26, wherein, in a further step after the lamination process, the support foil 3 is removed from the metal layer.

34. The method according to claim 33, wherein, after removal of the support foil 3, a supplemental metal layer 37 is applied electrolessly and/or electrolytically to the remaining base layer from which the support foil was removed.

35. The method according to claim 34, wherein the electrolessly and/or electrolytically coatable particles present in the remaining base layer 7 are at least partially exposed before the supplemental metal layer is formed on the remaining base layer from which the support foil was removed.

36. The method according to claim 34, wherein any existing oxide layer is removed from the electrolessly and/or electrolytically coatable particles before the supplemental metal layer is formed on the remaining base layer from which the support foil was removed.

37. The method according to claim 33, wherein, after removal of the support foil, any remaining portions of the base layer on the metal layer are chemically or mechanically removed.

38. The method according to claim 26, wherein the polymer is at least partially cured during lamination onto the support.
